(19) United States
(12) Patent Application Publication
(10) Pub. No.: US 2004/0153360 A1
(43) Pub. Date: Aug. 5, 2004

(54) System and method of message selection and target audience optimization

(76) Inventor: Douglas F. Schumann, Omaha, NE (US)

Correspondence Address: HEIMBECHER & ASSOCIATES, LLC., 390 UNION BLVD, SUITE 650, LAKEWOOD, CO, 80228-6512, US

(21) Appl. No.: 10/473,377

(22) PCT Filed: Mar. 28, 2002
(86) PCT No.: PCT/US02/09869

(51) Int. Cl. G06F 17/60

(52) U.S. Cl. 705/10

(57) ABSTRACT

A method and system that uses electronic message delivery combined with data collection techniques and data-mining methods to determine and enhance the effectiveness of a given communication and to optimize the target audience of the given communication. One embodiment of the system utilized in practicing the method also includes a means for collecting real-time, synchronized survey audience response data with respect to the videos presented and a data-mining tool for analyzing the data collected and the streaming videos presented. One embodiment of the system includes an audience manager (12), and invitation manager (14), and order manager (16), and a message manager (18). In one embodiment, the message manager (18) includes a testing process (20), a scoring process (22), a ranking process (24), and a response analysis process (26).

### CROSS-REFERENCE TO RELATED APPLICATION

This application claims priority to U.S. Provisional Application No. 60/279,643, filed Mar. 28, 2001 (the '643 application). The '643 application is hereby incorporated by reference as though fully disclosed herein.

### BACKGROUND OF THE INVENTION

1. Field of the Invention

This invention relates to a method and system for video communication testing and optimizing a target audience. More specifically, this invention relates to a method and system that uses electronic message delivery combined with data collection techniques and data-mining methods to determine and enhance the effectiveness of a given communication and to optimize the target audience of the given communication.

1. Background Information

Data collection systems related to video communications have been described in the art. A method and system for collecting audience response data related to viewing a particular video is discussed in U.S. Pat. No. 5,995,941. A method and apparatus for correlating real-time audience feedback with segments of broadcast programs is discussed in U.S. Pat. No. 6,134,531.

Data-mining is used in various fields and is well-known in the art or statistical analysis. For example, in marketing and advertising, data-mining is used to optimize market segments and for selecting customers for targeted marketing. Such a method and system is discussed in U.S. Pat. No. 6,061,658.

Market testing has traditionally been done using focus groups and hard-copy surveys, Such testing is often expensive and the turn-around time for obtaining analyzed results is often lengthy.

More recently developed marketing strategies utilize the Internet and electronic mail (e-mail) to more quickly and effectively reach target audiences. Various Internet marketing strategies are described in The Engaged Customer by Hans Peter Brondmo (Harper Business Press 2000) and The Handbook of Online Marketing Research by Joshua Grossnickel and Oliver Radkin (McGraw Hill 2001).

There is a need for a video communication testing system and system for optimizing a target audience that utilizes electronic mailing systems to lower costs and provide quick turn-around times for analyzing test results.

### SUMMARY OF THE INVENTION

The present invention is a system and method for video communication testing and optimizing a target audience.

The system includes a means for presenting at least one streaming video to at least one target audience selected from at least one reference audience pool. The system also includes a means for collecting real-time, synchronized survey audience response data with respect to the videos presented and a data-mining tool for analyzing the data collected and the streaming videos presented.

The method for video communication testing and optimizing a target audience includes the following steps:

selecting a reference audience pool;

selecting a survey audience from said reference audience pool;

presenting information to said survey audience;

collecting survey audience response data with respect to said information;

training a data-mining tool with said response data collected;

scoring said audience pool using said trained tool;

selecting said target audience from said audience pool based on said scores; and

presenting said information to said target audience.

### BRIEF DESCRIPTION OF THE DRAWINGS

FIG. 1 is a system flow diagram of one embodiment of the message management system;

FIG. 2 is a system flow diagram of the message management system and message manager module;

FIG. 3 is a system flow diagram of the audience manager module;

FIG. 4 is a system flow diagram of the invitation manager module;

FIG. 5 is a system flow diagram of the order manager module;

FIG. 6 is a detailed process flow diagram of the message manager testing process; and

FIG. 7 is a detailed process flow diagram of the message manager response analysis process.

### DETAILED DESCRIPTION OF THE PREFERRED EMBODIMENTS OF THE INVENTION

The present invention is a method and system that enables a message producer to determine and enhance the effectiveness of a given video message, and to optimize a selected target audience for the video message. Using electronic message delivery together with sophisticated data-collection techniques and data-mining methods, the invention enables and facilitates rapid optimization of message contact and target audience. In its preferred form, the invention includes a message management system, an audience manager, an invitation manager, an order manager, a message manager, and a data-mining model. Each of these is discussed further below.

Message Management System Overview

The message management system 10 primarily includes two stages: the message testing stage 11 and the final message stage 13. In the message testing stage, e-mail messages are tested against pre-selected standards. Test messages are revised or replaced until acceptable results are obtained. The accepted test messages are then sent to a test audience and response data is collected. The message testing stage is completed when the response data are processed by a data-mining model to develop scoring rules.

In the final message stage, the scoring rules are used to score the overall audience to obtain an optimal message audience. The accepted messages are then e-mailed to the optimal message audience. Response data and order data is collected.

The message management system 10 includes four cooperating management modules: an audience manager 12; an invitation manager 14; an order manager 16; and a message manager 18. The audience and invitation manager comprise the campaign and communication management modules within this system. The audience manager is used to control the audience composition, and during the time that the invitation manager controls when and how the messages will be sent and how recipients can reply. The order manager tracks audience responses to the messages and processes orders. The message manager manages which messages are sent to which audiences.

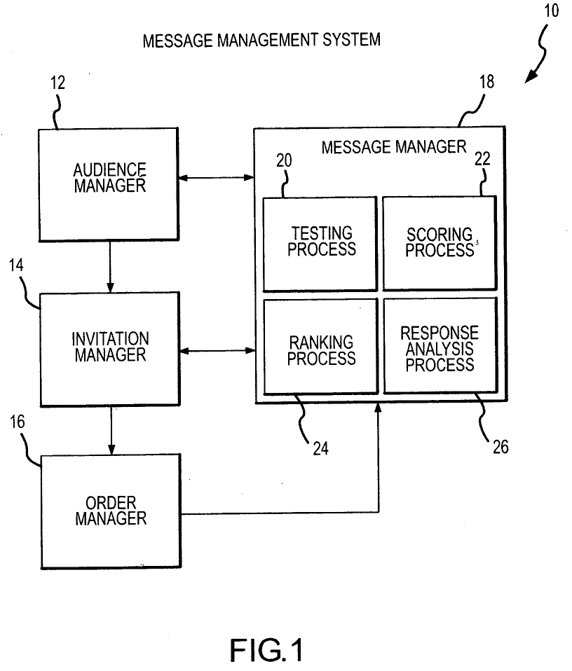

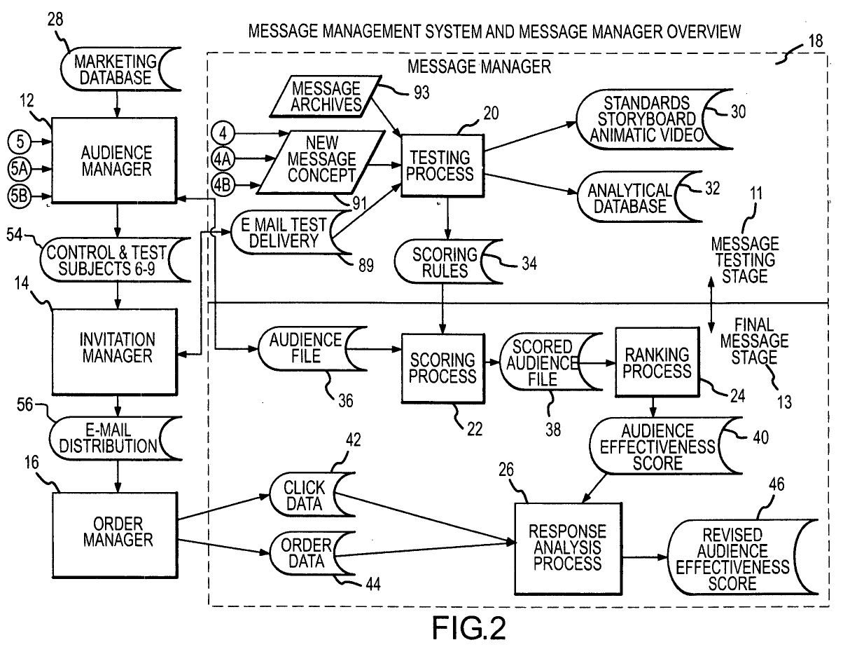

FIGS. 1 and 2 illustrate system flow diagrams for a preferred embodiment of the message management system. FIG. 1 illustrates the interaction between the four manager modules. FIG. 2 illustrates the interaction between the four manager modules and provides additional details with respect to the message manager.

As illustrated in FIG. 1, data flows from the audience manager 12 to the invitation manager 14 and from the invitation manager to the order manager 16. Additionally, data is exchanged between both the audience and invitation managers and the message manager 18. Finally, data also flows from the order manager to the message manager. The message manager includes four processes: a testing process 20; a scoring process 22; a ranking process 24; and a response analysis process 26. As a result, the message manager is the most complex of the four modules. Accordingly, additional details related to the message manager are provided in FIGS. 2, 6, and 7, and in the specification below.

As illustrated in FIG. 2, the audience manager 12 draws a selected audience from a marketing database 28. As illustrated in FIG. 2 and described in greater detail below, the audience manager 12 draws audience samples from the marketing database for two purposes. First, the audience manager 12 draws the audience selected to receive e-mail test messages (test subject or test audience). Second, the audience manager 12 draws the audience selected to receive final advertising e-mails or final message e-mails (message audience).

As illustrated in FIGS. 1 and 2, the audience manager 12 cooperates with both the invitation manager 14 and the message manager 18. The audience manager interacts with the invitation manager during both the message testing stage and final message stage of the system. In the message testing stage, the audience manager first draws a test audience from the marketing database 28. The audience manager transfers the test audience data to the invitation manager. The invitation manager determines the accompanying invitation format to be sent to the test audience and e-mails the invitation and test message to the test audience.

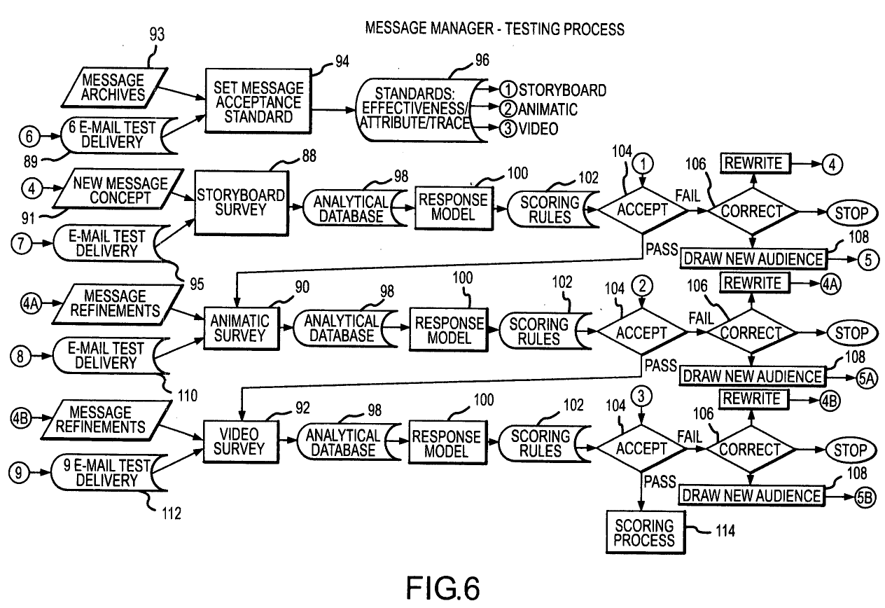

The message manager manages the testing process related to the test message e-mails as illustrated in detail in FIG. 6 and described below. Depending on the results of the testing process, the message manager may determine that a new test audience is required. If this occurs, the message manager transmits such an indication to the audience manager (arrow 5, 5A, 5B in FIG. 2). Upon receipt of such an indication from the message manager, the audience manager transmits another test audience data set to the invitation manager and the system process continues.

During the testing process, response data collected from viewers is measured against, pre-determined standards 30 to determine if the test message is acceptable. It may be determined that the content of the test message must be revised or replaced. If the testing process determines a new or revised test message is necessary, such an indication causes a new test message to be created or selected and the new test message is e-mailed to the same test audience as received the previous test message (arrow 4, 4A, 4B in FIG. 2). Additional details related to-the development of new test messages are illustrated in FIG. 6 and described below. After a test message is deemed acceptable, the test message is e-mailed to the test audience and data are collected and stored in an analytical database 32. The testing process data stored in the analytical database are processed using a data-mining modeling program. Preferred data-mining programs are based on a process model that utilizes chi square automatic interaction detection methods (“CHAID”). The data-mining program manipulates the test data to develop scoring rules 34. The scoring rules are used in the scoring process.

After scoring rules are developed from the testing process, the audience manager 12 delivers a message audience file 36 to the message manager 18. The message audience file is scored in a scoring process 22 using the scoring rules. The scored message audience file 38 is then analyzed in the ranking process 24. The ranking process develops a ranking list of particular test messages and particular audience segments (ranking process data). The ranking process data is transferred to the audience manager for further analysis. The audience manager develops an audience effectiveness score 40 from the ranking process data. The audience effectiveness score is used to select an e-mail distribution list. The e-mail message distribution list is transmitted to the invitation manager. The invitation manager prepares the final message for delivery and transfers the e-mail message distribution list and prepared e-mails to the order manager for e-mail distribution.

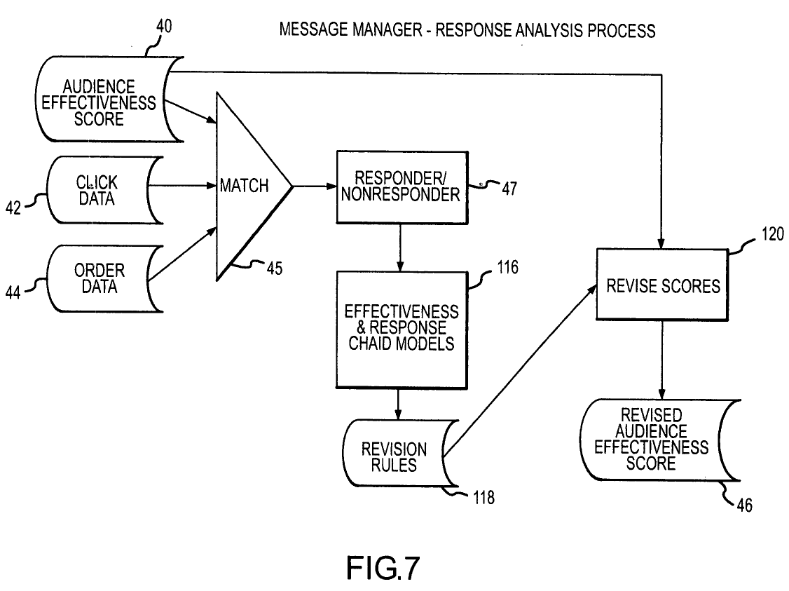

The order manager manages both the e-mail delivery and the responses of the viewers. The order manager communicates the viewer responses to the message manager. The viewer responses include click data 42 and order data 44. Both the click data and order data are transferred to the response analysis process 26 in the message manager. The response analysis process processes the data through the data-mining model to create revised audience effectiveness score 46. The revised audience effectiveness score is transmitted to the audience manager database to help determine future audiences. Additional details related to the message manager are illustrated in FIGS. 6 and 7 and as described below.

Audience Manager

In a preferred embodiment, the audience manager controls the test audience composition by selecting individuals from the marketing database and dividing them into control and test groups. Selection of control and test groups may be based on demographic markers or other statistically accepted means. The test groups can be further divided into several cells that receive different types of messages. The audience manager is used to draw samples from the test cells to participate in the message testing survey process. The audience manager also passes personalization information from the marketing database to the invitation manager for inclusion in the e-mail invitation letter. In a preferred embodiment, this system includes a marketing campaign tool combined with a marketing database.

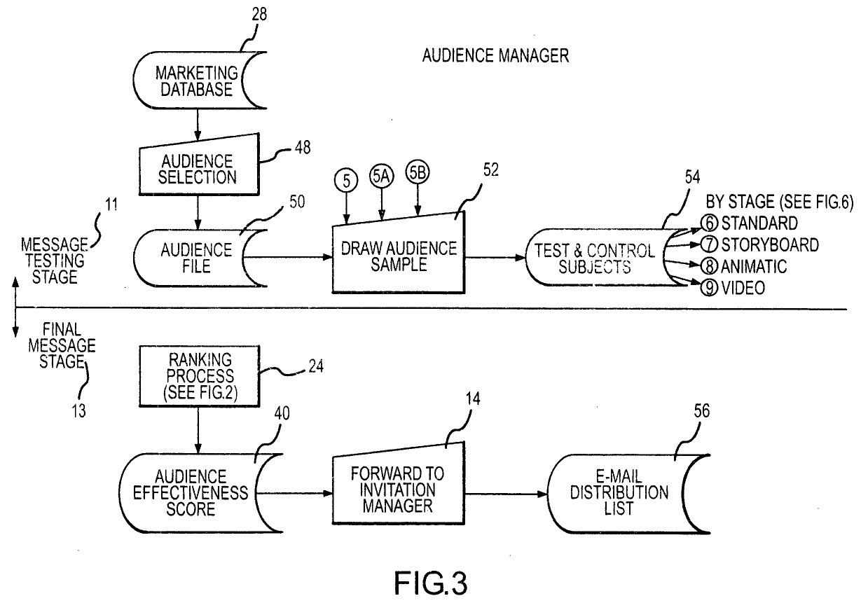

As illustrated in FIG. 3, the audience manager 12 is active in both the message testing stage 11 and the final message stage 13. In the message testing stage, the audience 48 is selected from a marketing database 28. From the audience file 50, the audience manager draws an audience sample or test audience 52. The test audience is used as a test and control subject group 54 in the message manager testing process. As mentioned above, the results of the testing process in the message manager may indicate that an additional audience sample is required. In that instant, such an indication is communicated to the audience manager and a new test audience is drawn. The new test audience is then transmitted to the message manager testing process.

In the final message stage 13, the function of the audience manager is to develop an audience e-mail distribution list 56 for e-mailing the final messages. The audience manager develops the audience effectiveness score 40 using the ranking process data developed by the message manager. The audience effectiveness score 40 is then used to select the message audience. A corresponding e-mail message distribution list is developed from the message audience data. The e-mail distribution list is transferred to the invitation manager 14.

Invitation Manager

The invitation manager 14 formats e-mail invitation letters, merges mail lists and letters, and schedules mail transmission. In the preferred embodiment, the invitation manager is an e-mail message format tool.

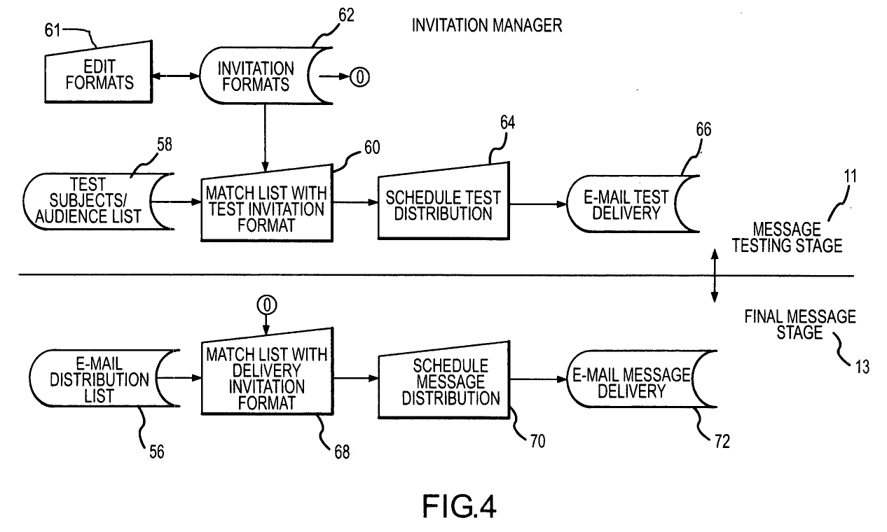

As illustrated in FIG. 4 and described herein, the invitation manager is also active in both the message testing stage 11 and the final message stage 13. In the message testing stage, the invitation manager manipulates the test subjects or test audience list 58 communicated from the audience manager to match the test audience list 60 with the appropriate invitation formats 62. After matching the test audience list with the appropriate test invitation formats and including personalization information from the marketing database in the invitations, the invitation manager schedules the message test distribution 64. The e-mail test is then delivered as scheduled 66. After the e-mail tests are delivered, the message manager testing process manages the e-mail test.

In the final message stage 13, the invitation manager matches the e-mail distribution list 56 developed by the audience manager to the appropriate invitation format 68 and includes personalization information from the marketing database in the invitations. The invitation manager next schedules message distribution 70. The invitation formats, e-mail distribution list, and schedule data are transferred to the order manager for delivery of the final messages 72.

Order Manager

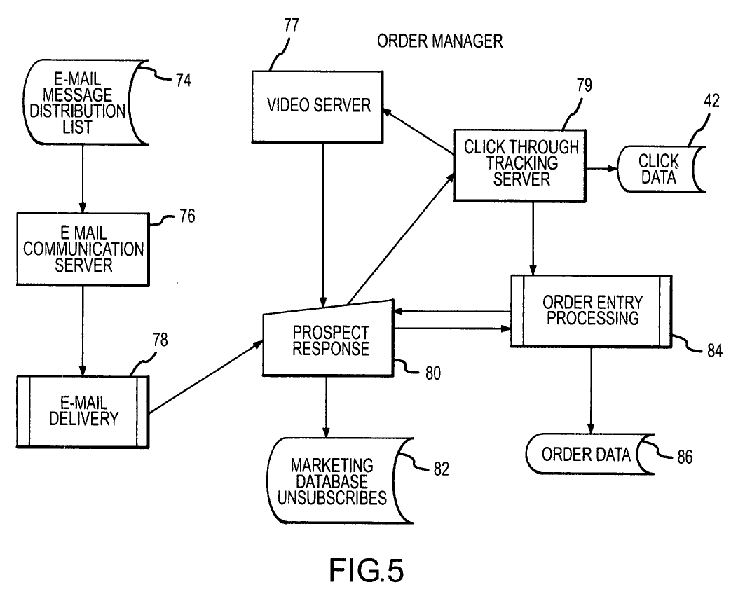

The order manager transmits e-mail, links to video servers, tracks video viewers, and serves as the bridge to customer order processing. In the preferred embodiment illustrated in FIG. 5, the order manager is a communication network server, a video server, a response server, and an order processing server.

In a preferred embodiment, the order manager is only active in the final message stage of the message management system. The order manager communicates the e-mail message distribution list 74 to the e-mail communication server 76 and causes the e-mail messages to be delivered 78. The order manager 16 manages the data generated from viewers' responses 80 to the e-mail messages.

Viewer responses to unsubscribe 82 from the e-mail mailing list are transmitted by the order manager to the marketing database. If a viewer indicates a desire to unsubscribe, the viewer's name is either removed from the marketing database or flagged to indicate their desire not to receive e-mail messages in the future. The order manager gathers click data 42 generated from the viewers response to the video message. The order manager tracks the viewers' responses to the video on a real-time basis to generate click data in the form of a response trace to the video. The order manager also collects click data generated from viewers' responses to questionnaires included in the e-mail message. The click data are then transmitted to the message manager for response analysis processing. The order manager also collects any orders that are entered by a viewer 84. The order data 86 is also transmitted to the message manager for response analysis processing. In addition, the order entry data is processed to fill the viewer's order.

Message Manager

The message manager module manages which messages are sent to which audience. It includes message testing, audience scoring, audience and message ranking, and response analysis sub-modules or processes. The message testing process generates data as numeric rating reactions to message copy and rating by attribute and for overall effectiveness and purchase intent. This rating data, along with open ended question responses is used in response modeling to determine who to direct the message to and why the message is effective. Response tracking is used to validate and revise the effectiveness scores based on audience reactions to e-mail messages and orders.

As described herein and illustrated in FIGS. 2, 6, and 7, the message manager includes four main processes: a testing process 20; a scoring process 22; a ranking process 24; and a response analysis process 26. The testing process is active during the test stage and the scoring, ranking, and response analysis process are active during the final message stage.

As described above, the testing process is used to evaluate any number of messages versus predetermined acceptance standards. As illustrated in FIG. 6, messages are developed using an iterative process. A new message is typically tested in storyboard form 88 first, in animatic form 90 second, and finally in video 92 form. Alternatively, a message may be selected from a message archive. In either case, message acceptance standards 94 are selected before testing the messages.

Examples of acceptance standards include overall effectiveness of a message, specific attributes of a message, and a trace of the viewers overall approval response to a message 96. When a message is delivered via e-mail, the test data collected is gathered in an analytical database 98. The data is then processed using a data-mining response model 100. The data-mining response model manipulates the data to develop scoring rules 102. The viewer response data collected from the testing process is compared to the message acceptance standards to determine if the test message is acceptable 104. If acceptable results were not obtained, the message or messages are modified or replaced, and the test is conducted again 106. If acceptable results are still not obtained after rewriting or replacing the message, the audience manager selects a new test subject audience to test the revised message against 108. After acceptable testing process results are obtained in the storyboard form of the test message, an animatic test message is developed from the storyboard 110. The animatic test message is then e-mailed to another test audience selected by the audience manager. The animatic test message results are processed using the same process used with the storyboard message and described above. The scoring rules are revised during the process. When an acceptable test result is obtained from the animatic test message, the animatic test message is developed into a video test message 112. The video test message is then e-mailed to a new test audience selected by the audience manager. The video test message results are processed the same as-both the storyboard and animatic test messages. When an acceptable video test message is found, the results of the testing process utilizing the video test message are collected in an analytical database and manipulated by a data-mining response model to further revise the scoring rules 114. The scoring rules are used in the scoring process.

The scoring process, ranking process, and response analysis process are all performed after the testing process has been completed and scoring rules have been developed. The audience manager selects an audience file typically based on demographic criteria. The audience file is then introduced to the scoring process. In the scoring process, the scoring rules are applied against the audience file to develop a scored audience file. Next, the scored audience file is transmitted to the ranking process.

The ranking process ranks either the various messages displayed or the various audience segments. From the ranking process, ranking process data are created. The ranking process data developed during the ranking process are then transmitted to the audience manager. The ranking process data are used to develop an audience effectiveness score. The audience effectiveness score is used to select a message audience from the audience file. The message audience data is converted to an e-mail message distribution list. The e-mail message distribution list is transferred to the invitation manager for further processing. The audience effectiveness score is also communicated to the response analysis process 26 in the message manager 18. The response analysis process is illustrated in FIG. 7 and described below.

The response analysis process correlates the audience effectiveness score 40, the click data 42, and the order data 44, to develop revised audience effectiveness scores 46. The effectiveness score, click data, and order data are correlated with the viewer responses to the e-mail messages and processed using the data-mining models 116. The data-mining models are used to revise the scoring rules developed in the testing process 118. The revised rules are then used to revise the scores 120 and revise the audience effectiveness score 46. The revised audience effectiveness score can be used to select a revised message audience.

Data-Mining Model

The purpose of the data-mining model is to provide an expected score for message effectiveness for not only survey participants but also for audience populations. These predictions are based on the audience demographic similarities to the survey participants who were drawn as a random or stratified sample from the audience population. Survey response ratings, tracings, and demographic data are used to find relationships to make predictions of what scores could be expected if the entire audience had participated in the survey. The predicted effectiveness scores are used to determine which messages are directed to designated audiences.

The preferred method, chi square automatic interaction detection (“CHAID”), can be used to estimate models to provide predicted scores for effectiveness. This method relates the mean value of the dependent variable to different ranges of the independent variable, for example, Y=3 when 1<X<4; and Y=3.5 when X=4; and Y=4 when X=5. Several different independent variables can be included in the model, including demographic groupings. These variables can also interact. CHAID models are displayed as trees with branches having different mean scores for the dependent variable and different ranges for the independent variable. Interactions among the independent variables are displayed as further branching until an end node (leaf) is reached when no further significant differences in the dependent mean are found. The end node (leaves) dependent mean scores can also be sorted and listed to produce ranking reports. The CHAID model/trees are also expressed mathematically as IF THEN logical rules that can be used programmatically in a scoring algorithm. One acceptable CHAID model program, KnowledgeExcelerator™, was developed by ANGOSS Software Corporation. Additional information on KnowledgeExcelerator™ and ANGOSS Software Corporation can be found on the Internet at www.angoss.com. While the CHAID method utilized in KnowledgeExcelerator™ is included in the preferred embodiment, anyone skilled in the art could utilize any one of several statistical estimation techniques.

Ordinary least squares (OLS) regression is one of several methods that could be used to estimate score models. Using this method, the change in the dependent variable, effectiveness, is related to the change in one of more independent variables such as informative or amusing attribute ratings or particular time segment tracing scores. OLS regressions estimations are expressed as Y=a+bX, where Y is the dependent and X is the independent variable. Demographic variables can also be used in regression as dummy variables with 1 indicating that a specific case record is for a member within a specified group, and 0 indicating non-membership. The estimation could then be Y=a+bX1+cX2+dD1+eD2, where a is an intercept term, b and c are slope parameters for attribute ratings X1 and X2, and d and e are shift terms for two demographic groups.

A back propagation neural network could also serve as a method to estimate effectiveness scores. This method's advantage over OLS regression is the ability to relate the rates of change in the dependent variable to the rates of change in independent variables in different ranges. The effectiveness score may not change much with changes in informative when informative is in a low range (1-3), but effectiveness may change (rise) rapidly with small changes in informative when informative is in a high range (4-5). Neural networks are built as a set of weights arranged in layers or slabs with input, hidden, and output layers. Neural network can be very powerful but also hard to review and describe.

Alternative Embodiments

Instead of sending e-mail via the Internet, test messages and final messages could also be displayed to audiences in facilities such as lecture halls or class rooms. The message testing process and final message delivery could also be executed fully without an Internet server by embedding the video directly in the e-mail and recording responses directly in a file within the e-mail, and directing a reply to a return e-mail address for processing.

One use of the message management system and method described herein is for a rapid advertising copy testing. Additional uses include the testing of new products and uses in the legal field (i.e., jury consultants). Many other uses for this novel system and method are contemplated but not described herein.

The invention has been described in detail while referring to specific embodiments thereof. However, since it is known that others skilled in the art will, upon learning of the invention, readily visualize yet other embodiments of the invention that are within the spirit and scope of the invention, it is not intended that the above description be taken as a limitation on the spirit and scope of this invention.

What is claimed is:

1. A method for selecting an optimal target audience, said method comprising the steps of
selecting a reference audience pool;
selecting a survey audience from said reference audience pool;
presenting information to said survey audience;
collecting survey audience response data with respect to said information;
training a data-mining tool with said response data collected;
scoring said audience pool using said trained tool;
selecting said target audience from said audience pool based on said scores; and
presenting said information to said target audience.

2. A method for optimizing a target audience, comprising the steps of:
selecting a reference audience pool;
selecting a survey audience from said reference audience pool;
presenting a video to said survey audience;
collecting real-time, synchronized survey audience response data with respect to said video;
training a data-mining tool with said data collected;
scoring said audience pool using said trained tool;
selecting said target audience based on said scores; and
presenting said video to said target audience.

3. A method for optimizing a target audience, comprising the steps of:
selecting a reference audience pool;
selecting a survey audience from said reference audience pool;
presenting a streaming video to said survey audience using electronic means;
collecting real-time, synchronized survey audience response data with respect to said video;
training a data-mining tool with said data collected;
scoring said audience pool using said trained tool;
selecting said target audience based on said scores; and
presenting said streaming video to said target audience using electronic means.

4. A method for optimizing at least one target audience, comprising the steps of:
selecting at least one reference audience pool;
selecting at least one survey audience from said at least one reference audience pool;
presenting at least one streaming video to said at least one survey audience using electronic means;
collecting real-time, synchronized survey audience response data with respect to said at least one video;
training a data-mining tool with said data collected;
scoring said at least one audience pool using said trained tool;
selecting said at least one target audience based on said scores; and
presenting said at least one streaming video to said at least one target audience using electronic means.

5. The method for optimizing at least one target audience in claim 4, further comprising the step of selecting said at least one streaming video based on said scores, wherein said at least one streaming video selected is presented to said at least one target audience using electronic means.

6. A method for video communication testing and optimization for at least one target audience, comprising the steps of:
selecting at least one reference audience pool;
selecting at least one survey audience from said at least one reference audience pool;
presenting at least one streaming video to said at least one survey audience using electronic means;
collecting real-time, synchronized survey audience response data with respect to said at least one video;
training a data-mining tool with said data collected;
scoring said at least one audience pool using said trained tool;
selecting said at least one target audience based on said scores;
selecting said at least one streaming video based on said scores; and
presenting said at least one streaming video selected to said at least one target audience using electronic means.

7. A method for video communication testing, comprising the steps of:
selecting at least one reference audience pool;
selecting at least one survey audience from said at least one reference audience pool;
presenting at least one streaming video to said at least one survey audience using electronic means;
collecting real-time, synchronized survey audience response data with respect to said at least one streaming video;
training a data-mining tool with said data collected;
scoring said at least one audience pool using said trained tool; and
selecting said at least one streaming video based on said scores.

8. A system for video communication testing and optimization of at least one target audience, the system comprising:
a means for presenting at least one streaming video to said at least one target audience, wherein said at least one target audience is selected from at least one reference audience pool;
a means for collecting real-time, synchronized survey audience response data with respect to said at least one video; and
a data-mining tool for analyzing said data collected and said at least one streaming videos presented.

9. A message management system to test and optimize a message for a test audience, the system comprising
an audience manager;
an invitation manager;
an order manager; and
a message manager.

10. The message management system of claim 9, wherein said message manager further comprises
a testing processor;
a scoring processor;
a ranking processor; and
a response analysis processor.
